(19) United States
(12) Patent Application Publication
(10) Pub. No.: US 2026/0370586 A1
(43) Pub. Date: Nov. 19, 2026

(54) INTEGRATED KEY PERFORMANCE INDICATOR (KPI) MONITORING FOR MANAGING SURGE SLICE NETWORKING

(71) Applicant: T-Mobile USA, Inc., Bellevue, WA (US)

(72) Inventors: Ryan Christopher Lindstrom, De Soto, KS (US); George Jason Schnellbacher, Leawood, KS (US); Matthew John Starzec, Leesburg, VA (US)

(21) Appl. No.: 19/212,059

(22) Filed: May 19, 2025

(51) Int. Cl. H04L 43/0876; H04L 41/142

(52) U.S. Cl. CPC H04L 43/0876; H04L 41/142

(57) ABSTRACT

A server system for managing surge network slicing in a telecommunications network can receive a first set of key performance indicator (KPI) values from a base station indicating a network slice’s performance from the base station’s perspective during a specific time period. Simultaneously, the system can receive a second set of KPI values from an electronic device, capturing the device’s experience of the same network slice. The system can merge the two sets of KPI values and identify discrepancies between the two sets of KPI values received from the base station and the electronic device. The system can determine whether the electronic device requires an upgrade of the network slice and can initiate the process to establish the upgrade when needed.

### BACKGROUND

Key performance indicators (KPIs) are metrics used to evaluate and monitor the performance, reliability, and efficiency of telecommunications networks. In the context of modern telecommunications, KPIs encompass a wide range of parameters, including but not limited to network availability, latency, throughput, packet loss, jitter, and call drop rates. KPIs are important for managing network performance because they provide quantifiable metrics that enable operators to monitor, assess, and optimize the quality, reliability, and efficiency of telecommunications networks, ensuring service standards are met and issues are promptly addressed. KPIs can provide quantitative data that network operators and service providers use to assess service quality, optimize resource allocation, and ensure compliance with service level agreements.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates an environment for managing network performance in accordance with some embodiments.

FIG. 4 is a flow chart that illustrates a process for managing network performance using KPIs in accordance with some embodiments.

FIG. 5 is a flow chart that illustrates a process for managing network performance using KPIs obtained via a subscriber identity module (SIM) applet on an electronic device in accordance with some embodiments.

FIG. 6 is a block diagram that illustrates an example of a computer system in which at least some operations described herein can be implemented.

FIG. 7 is a block diagram that illustrates an example of an artificial intelligence (AI) system in which at least some operations described herein can be implemented.

FIG. 8 is a block diagram that illustrates an example network slicing environment in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology is directed to monitoring integrated key performance indicators (KPIs) for managing surge slice networking. Surge slice networking can enable the dynamic allocation and management of dedicated network resources (i.e., slices) to handle changing needs for bandwidth, latency, or other network services. For example, surge slice networking can be used in network environments to provide optimal performance and service quality even during peak usage periods by isolating and prioritizing critical traffic flows. Real-time monitoring of network performance is important for network service providers so that surge slice networking can be provided to user devices that are in need of improved network performance. However, conventional technologies do not provide efficient manners for monitoring network performance, as experienced by user devices, in real time. Furthermore, conventional technologies fail to provide reliable and dynamic predictions of network performance as experienced by user devices.

Conventionally, the network service providers use KPIs collected by base stations or other network infrastructure equipment for monitoring the network performance. Such KPIs can include, for example, signal strength, throughput, latency, error rates, packet loss, and jitter. Even though the collected KPIs can be used for real-time identification of performance issues on the network side, conventional methods fail to provide real-time information regarding the network performance experienced by the user devices. The network performance experienced by the user devices can be different (reduced) from the network performance experienced by the network infrastructure. As an example, extrinsic factors such as user device density, geographical terrain, user device mobility, physical obstructions, radio interference, or weather can reduce the quality of network performance experienced by user devices.

In order to provide accurate and timely surge slice networking services to users, there is a need for real-time monitoring of network performance KPIs, as experienced by the user devices. The present technology provides for methods and systems simultaneously collecting sets of KPIs from network infrastructure and a user device, and generating a merged set of KPIs. The merged set of KPIs can be processed to identify discrepancies between the network performance experienced by the network infrastructure and the user device. The discrepancies can be used for determining whether the user device requires an upgrade of an existing network service. Furthermore, the discrepancies can be used to predict whether the user device is likely to require such an upgrade in the near future. Using the determination and/or prediction, the system can provide an upgraded network service (e.g., a surge network slice) to the user device.

In some implementations of the present technology, the KPIs describing the network performance as experienced by the user device are collected by the device’s hardware or operating system. For example, a modem and radio chipset of a user device can be configured to collect signal strength and signal quality KPIs. The operating system can be configured to enable network performance monitoring by software applications via application programming interfaces (APIs). The software application can be configured to access KPIs such as latency, throughput, and packet loss. In some implementations, the KPIs can be collected via small-sized, specialized software programs (e.g., applets) embedded within a subscriber identity module (SIM) of a user device. Such specialized software programs can be programmed to access and collect a variety of KPIs that provide information about the network performance experienced by the user device.

In one example, a server system for managing surge network slicing can receive a first set of key performance indicator (KPI) values from a base station of the telecommunications network. The first set of KPI values can indicate the performance of a network slice of the telecommunications network during a time period as experienced by the base station. The system can also receive a second set of KPI values from an electronic device in communication with the base station via the network slice. The second set of KPI values can describe the performance of the network slice as experienced by the electronic device during the time period. The system can merge the first set of KPI values and the second set of KPI values to generate a merged set of KPI values indicative of the performance of a network slice of the telecommunications network during the time period as experienced by the base station and the performance of the network slice as experienced by the electronic device during the time period. The system can identify, using the merged set of KPI values, one or more discrepancies between the first set of KPI values and the second set of KPI values. Based on the identified one or more discrepancies, the system can identify whether the electronic device requires an upgrade of the network slice. In response to an identification that the electronic device requires an update to the first network slice, the system can initiate the establishment of the upgrade of the network slice.

In another example, a method performed by a server system for managing surge network slicing in a telecommunications network can include receiving a first set of key performance indicator (KPI) values from a base station of the telecommunications network. The first set of KPI values can indicate performance of a network connection of the telecommunications network during a time period as experienced by the base station. The method can further include receiving a second set of KPI values from an electronic device in communication with the base station via the network connection. The second set of KPI values can describe performance of the network connection as experienced by the electronic device during the time period. The method can also include merging the first set of KPI values and the second set of KPI values to generate a merged set of KPI values indicative of the performance of a network slice of the telecommunications network during the time period as experienced by the base station and the performance of the network slice as experienced by the electronic device during the time period. The merged set of KPI values can be used to identify one or more discrepancies between the first set of KPI values and the second set of KPI values. Based on the identified one or more discrepancies, the method can identify whether the electronic device has a probability of experiencing an interruption in the network connection that fails to satisfy a threshold probability value. In response to identifying that the electronic device has the probability of experiencing the interruption in the network connection that fails to satisfy the threshold probability value, the method can include performing an action to mitigate the probability of experiencing the interruption.

In yet another example, a system can receive a first set of key performance indicator (KPI) values from a base station of the telecommunications network. The first set of KPI values can indicate performance of the network connection of the telecommunications network during a time period as experienced by the base station. The system can also include functionality to receive a second set of KPI values from an electronic device in communication with the base station via the network connection. The second set of KPI values can describe performance of the network connection as experienced by the electronic device during the time period. The system can further include functionality to merge the first set of KPI values and the second set of KPI values to generate a merged set of KPI values indicative of the performance of a network slice of the telecommunications network during the time period as experienced by the base station and the performance of the network slice as experienced by the electronic device during the time period. The merged set of KPI values can be used to identify one or more discrepancies between the first set of KPI values and the second set of KPI values. Based on the identified one or more discrepancies, the system can identify whether the electronic device has a probability of experiencing an interruption in the network connection that fails to satisfy a threshold probability value. In response to identifying that the electronic device has the probability of experiencing the interruption in the network connection that fails to satisfy the threshold probability value, the system can perform an action to mitigate the probability of experiencing the interruption.

In yet another example, a method performed by an electronic device for managing network performance of a telecommunications network can include communicating with a base station of the telecommunications network via a network connection between the electronic device and the telecommunications network. The electronic device can include a subscriber identity module (SIM) associated with a service provider of the telecommunications network, where the SIM can include an applet configured to monitor key performance indicator (KPI) values that indicate the telecommunications network’s performance as experienced by the electronic device. While communicating with the base station, the applet of the SIM can obtain a first set of KPI values, where the electronic device can obtain the first set of KPI values by monitoring the values of KPIs during a time period. The electronic device can transmit the first set of KPI values to a server system associated with the telecommunications network, and the server system can merge the first set of KPI values with a second set of KPI values received from the base station to generate a merged set of KPI values, where the second set of KPI values can indicate performance of the network connection as experienced by the base station during the time period. The merged set of KPI values can be therefore indicative of the performance of a network slice of the telecommunications network during the time period as experienced by the base station and the performance of the network slice as experienced by the electronic device during the time period. The server system can identify, using the merged set of KPI values, one or more discrepancies between the first set of KPI values and the second set of KPI values, and, using the identified discrepancies, can determine whether the electronic device has a probability of experiencing an interruption in the network connection that fails to satisfy a threshold probability value; in response to identifying that the electronic device has the probability of experiencing the interruption in the network connection that fails to satisfy the threshold probability value, the system can perform an action to mitigate the probability of experiencing the interruption.

In yet another example, an electronic device in communication with a telecommunications network can include a subscriber identity module (SIM) associated with a service provider of the telecommunications network, and the SIM can include an applet configured to monitor key performance indicator (KPI) values that indicate the telecommunications network’s performance as experienced by the electronic device. The electronic device can further include at least one hardware processor and at least one non-transitory memory storing instructions, which, when executed by the hardware processor, can cause the electronic device to, while communicating with a base station via a network connection, obtain a first set of KPI values by the applet of the SIM and transmit the first set of KPI values to a server system associated with the telecommunications network. The server system can use the first set of KPI values together with a second set of KPI values received from the base station to identify one or more discrepancies between the first set of KPI values and the second set of KPI values. Using the identified discrepancies, the server system can determine whether the electronic device has a probability of experiencing an interruption in the network connection that fails to satisfy a threshold probability value, and, in response to identifying that the electronic device has the probability of experiencing the interruption in the network connection that fails to satisfy the threshold probability value, the system can perform an action to mitigate the probability of experiencing the interruption.

In yet another example, a server system for managing surge network slicing in a telecommunications network can receive, from an electronic device in communication with a base station of the telecommunications network via a network connection, a first set of key performance indicator (KPI) values associated with the telecommunications network, where the first set of KPI values are obtained by an applet of a subscriber identity module (SIM) of the electronic device during a time period. The system can merge the first set of KPI values with a second set of KPI values received from the base station to generate a merged set of KPI values, where the second set of KPI values indicate performance of the network connection as experienced by the base station during the time period. The merged set of KPI values can be therefore indicative of the performance of a network slice of the telecommunications network during the time period as experienced by the base station and the performance of the network slice as experienced by the electronic device during the time period. The system can identify, using the merged set of KPI values, one or more discrepancies between the first set of KPI values and the second set of KPI values. Using the identified discrepancies, the system can determine whether the electronic device has a probability of experiencing an interruption in the network connection that fails to satisfy a threshold probability value, and, in response to identifying that the electronic device has the probability of experiencing the interruption in the network connection that fails to satisfy the threshold probability value, the system can perform an action to mitigate the probability of experiencing the interruption.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

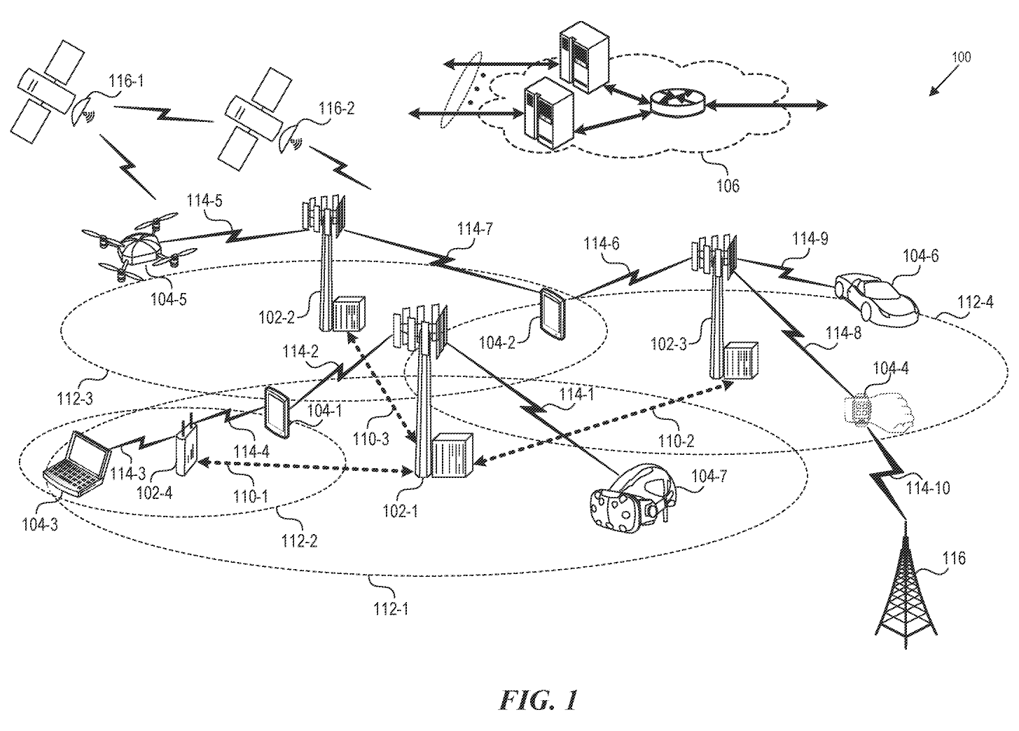

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

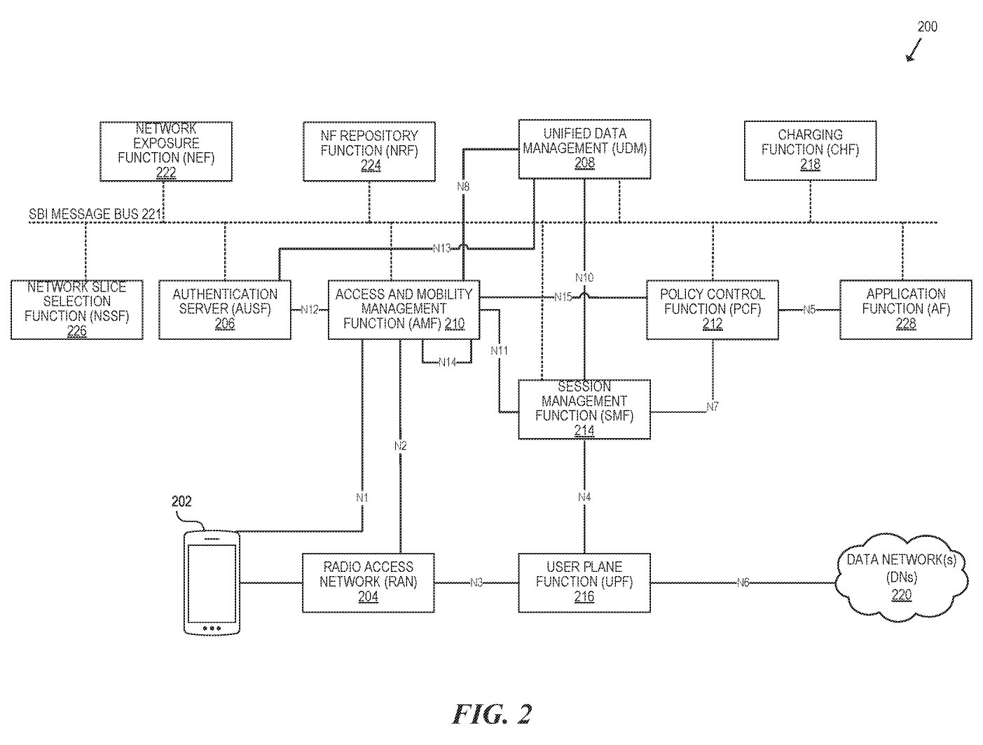

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Managing Network Performance Using KPIs

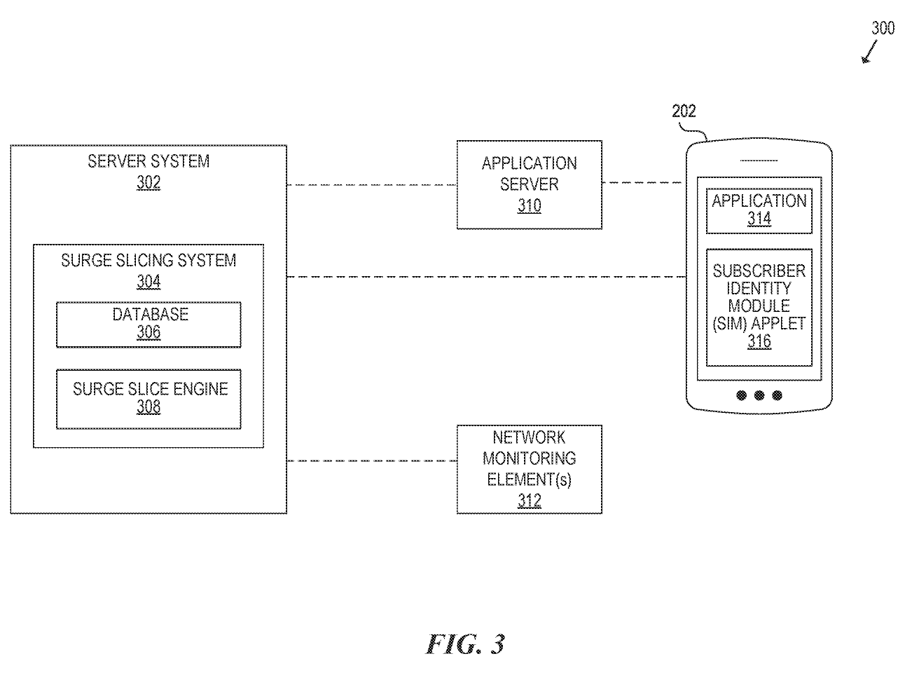

FIG. 3 is a block diagram that illustrates an environment 300 for managing network performance in accordance with some embodiments. The environment 300 is also configured to monitor network performance, as experienced by wireless devices and the network provider infrastructure. The environment 300 includes a server system 302, one or more network monitoring elements 312 (e.g., elements of network infrastructure that can monitor network performance), and wireless devices (e.g., the wireless device 202 shown in FIG. 3). The server system 302 can be associated with a telecommunications network (e.g., the network 100 described with respect to FIG. 1). The wireless device 202 is in communication with the wireless device network associated with the server system 302. The network monitoring elements 312 can include infrastructure associated with the network configured to monitor the performance of the network.

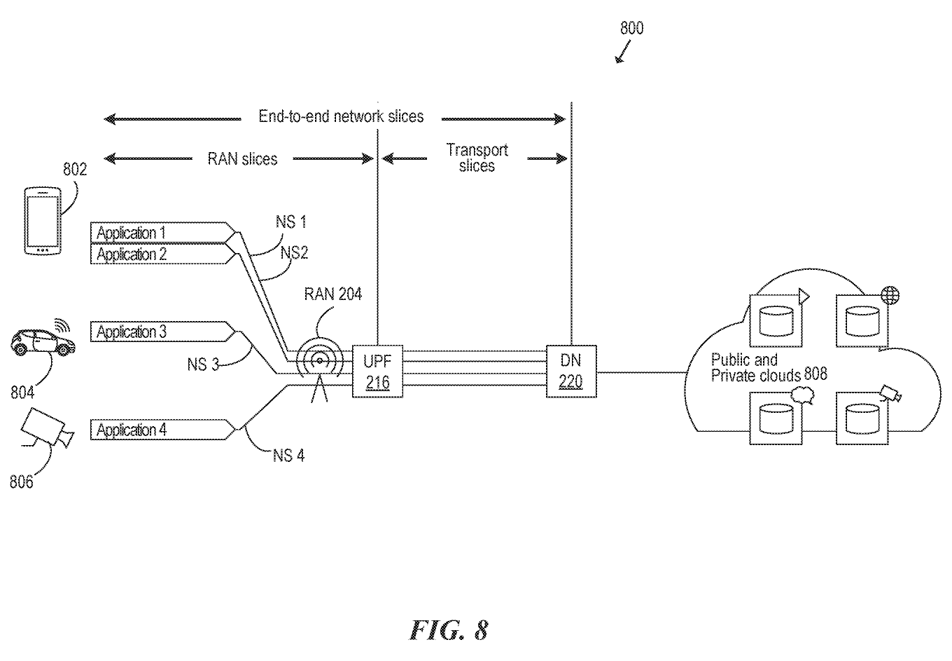

In some implementations, the environment 300 is configured to provide surge network slice services to wireless devices. Network slicing refers to a technology that enables the creation of multiple virtual networks on a shared physical infrastructure. A network slice can be tailored to specific service requirements and performance needs. Operation of network slicing is described with respect to FIG. 8. Surge network slicing can refer to dynamic allocation and scaling of network slices to handle fluctuating demand. In particular, surge network slicing can be used to address sudden demand for increased network performance, e.g., during large events or emergencies. Surge slicing can allow operators to rapidly provision additional resources to specific slices, ensuring consistent quality of service and reliability for critical applications or user groups during traffic surges. By leveraging automation and real-time analytics, surge network slicing optimizes network efficiency and user experience under fluctuating load conditions. For example, the server system 302 can be in communication with the DN 220 and the UPF 216 of the architecture 200 described with respect to FIGS. 2 and 8 to facilitate establishment of network slice connections for the wireless devices.

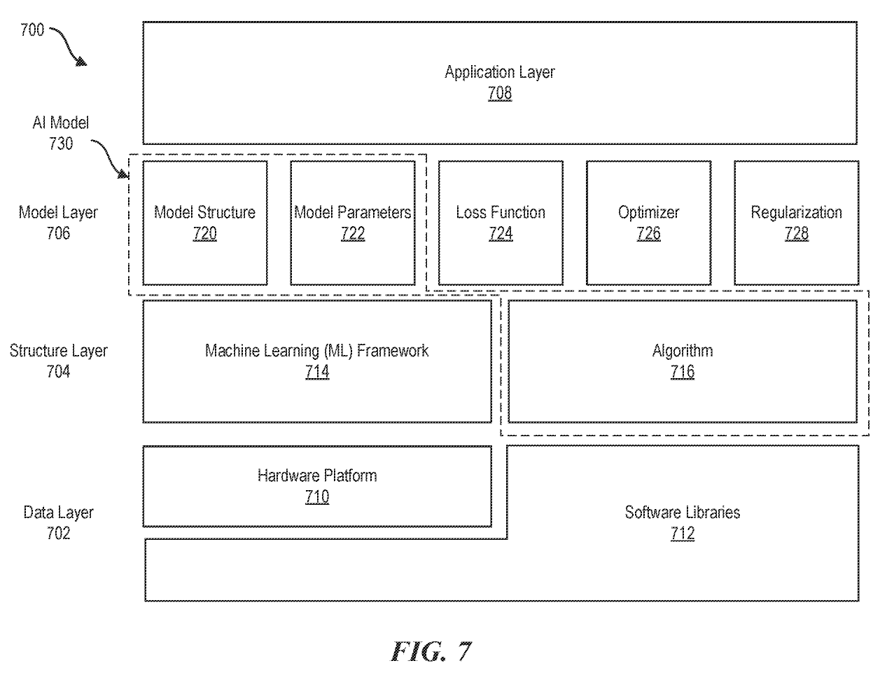

The server system 302 comprises a surge slicing system 304 (e.g., a sub-system) that includes (or is in communication with) a database 306 (or a datastore) and a surge slice engine 308. The server system 302 is configured to receive/process KPI values associated with the wireless devices that describe the performance of the network (e.g., a network slice) as experienced by the wireless devices. The server system 302 is also configured to receive/process KPI values associated with the network monitoring elements 312 that describe the performance of the network as experienced by the network (i.e., network infrastructure). The server system 302 can store the received KPI values to the database 306 so that the KPI values are merged with a common set of KPI values for processing. The merged set of KPI values can be indicative of the performance of a network slice of the telecommunications network during the time period as experienced by the base station and the performance of the network slice as experienced by the electronic device during the time period. In particular, the merged set of KPI values including the values received from the wireless devices and the network monitoring infrastructure can be used for determining or predicting whether a wireless device would require, or benefit from, an upgrade of the network connection now or in the near future. The upgrade can be, for example, a network slice defined by a different set of parameters that can provide better bandwidth, latency, jitter, packet loss, etc. The determination can be performed by the surge slice engine 308. In some implementations, the surge slice engine 308 includes, or is in communication with, an AI system (e.g., an AI system 700 described with respect to FIG. 7). The surge slice engine 308 can use trained AI models to perform real-time determinations or predictions using the merged KPI values from the database 306.

The network monitoring elements 312 can be configured to collect/process/generate KPI values. The network monitoring elements 312 can include base stations (e.g., the base stations 102 in FIG. 1). Base stations can continuously collect KPI values by monitoring various aspects of network operation (e.g., signal strength, signal quality, latency, throughput, packet loss, jitter, connection drop rate, handover success rate, call setup success rate, data session setup success rate, battery consumption, or network availability). The KPI values can be obtained through embedded software and hardware sensors within the base station, which can log real-time performance metrics and report them to the server system 302.

The network monitoring elements 312 can also include other network elements that collect KPI values. For example, core network elements such as Mobile Switching Centers (MSCs), Serving/Packet Gateways (SGWs/PGWs), Evolved Packet Core (EPC), and 5G Core (5GC) can gather KPIs like call and session setup success rates, mobility management success, data session duration, signaling load, latency, and throughput to monitor end-to-end service quality and core network efficiency. Transport network equipment, including routers, switches, optical transport nodes, and microwave links, can collect KPIs such as packet loss, jitter, latency, bandwidth utilization, and link availability to ensure reliable data transmission and maintain backbone performance. Radio Access Network (RAN) controllers, such as Radio Network Controllers (RNCs), Base Station Controllers (BSCs), and the Distributed and Centralized Units (DUs/CUs) in 5G, can collect KPIs like handover success rate, resource block utilization, interference levels, and user scheduling efficiency to optimize radio resource management. Customer premises equipment (CPE), including home gateways, modems, set-top boxes, and enterprise routers, can collect KPIs related to connection uptime, signal quality, throughput, and error rates to monitor last-mile connectivity and end-user experience. Network management and monitoring systems, such as a Network Management System (NMS), an Element Management System (EMS), and a Performance Management System (PMS), can aggregate and correlate KPIs from all network layers and elements. Additionally, cloud and data center infrastructure, including virtualized network functions (VNFs), servers, storage, and load balancers, can collect KPIs on resource utilization, virtual machine performance, application response time, and network latency to ensure efficient operation of cloud-based network services and applications. The KPI values collected by one or more of the above-described infrastructure elements can be transmitted to the server system 302.

The wireless device 202 can also be configured to collect/process/generate KPI values and transmit the KPI values to the server system 302. The KPI values can be collected through a combination of hardware-based and operating system-based mechanisms. For example, the hardware components, such as the modem, radio transceivers, antennas, and sensors, directly interact with the cellular network to measure low-level radio and network parameters. For instance, the modem or radio chipset of a wireless device can capture signal strength indicators like RSSI (Received Signal Strength Indicator), RSRP (Reference Signal Received Power), RSRQ (Reference Signal Received Quality), and SINR (Signal-to-Interference-plus-Noise Ratio). The antenna can receive the physical radio signals, enabling the device to assess coverage and interference, while the Global Positioning System (GPS) module provides location data that can be correlated with network performance for geo-tagged KPI analysis. Further, sensors, such as accelerometers and gyroscopes, can help determine device movement, which is relevant for mobility-related KPIs like handover success. An operating system can act as an intermediary by providing application programming interfaces (APIs) and system services that access, aggregate, and interpret the raw data from the hardware. The operating system can aggregate measurements from the modem and sensors, such as signal strength, data throughput, latency, and error rates, and can also monitor application-level KPIs like app data usage, connection setup times, and service availability. The operating system can facilitate logging and reporting KPIs, either storing them locally or transmitting them to the server system 302 through diagnostic tools, background services, or standardized frameworks (e.g., 3GPP’s Minimization of Drive Tests (MDT)). Additionally, the operating system can collect user-centric KPIs, such as call drop events, failed data sessions, and battery consumption related to network activity.

In some implementations, applications (e.g., an application 314 operating on the wireless device 202) on a user device collect KPI values by accessing network performance data through operating system APIs. The application can collect, for example, signal strength, data throughput, latency, and error rates, often supplementing this information with device location and usage context associated with the application. The application can log these KPI values locally or periodically transmit them to the server system 302 or an application server (e.g., an application server 310) associated with the application. In some implementations, the application 314 transmits the KPI values collected by the application to the application server 310, which then further can transmit the KPI values to the server system 302. In some implementations, the application 314 is an application configured to monitor the network performance. In some implementations, the application 314 is an application configured to provide other functions and services. The functions and services can require usage of the network connection by the network 100. The application 314 can be, for example, configured to provide video or audio streaming, web browsing, video conferencing, live broadcasting, cloud gaming, screen sharing, remote desktop streaming, live streaming (e.g., sports, concerts), social media, and/or other applications requiring network streaming. The application 314 can also be related to the augmented reality/virtual reality (AR/VR) operations, autonomous vehicle operations, Internet of Things (IoT) operations, or other wireless device operations requiring a network connection.

In some implementations, the KPI values are collected by one or more applets of a SIM on the wireless device (e.g., the SIM applet 316 in FIG. 3). An applet can refer to a small application programmed to perform a specific task within a larger program or web page, for example, in a controlled environment such as a SIM. The SIM applet 316 can be programmed to collect KPI values from the wireless device 202. The SIM applet 316 can also facilitate the transmission of the KPI values from the wireless device 202 to the server system 302. The SIM can be a physical SIM card or an embedded SIM (eSIM). For example, an eSIM can be an embedded chip within a wireless device configured to store wireless network credentials, enabling users to activate, switch, or manage carrier profiles without needing a physical SIM card. SIM applets can be installed and updated remotely over-the-air (OTA) using secure communication protocols, for example, via Short Message Service (SMS) or data channels, allowing mobile operators to deploy, manage, and upgrade applets on SIM cards without physical access to the device. Alternatively, SIM applets can be pre-installed on a SIM prior to associating the SIM with a wireless device.

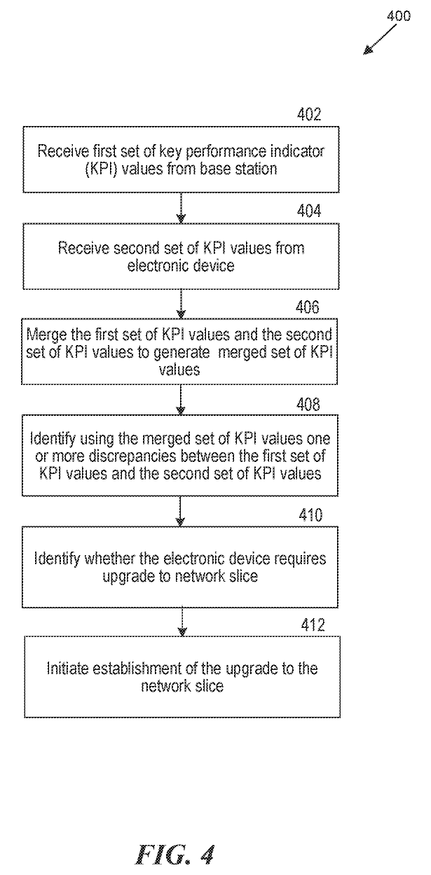

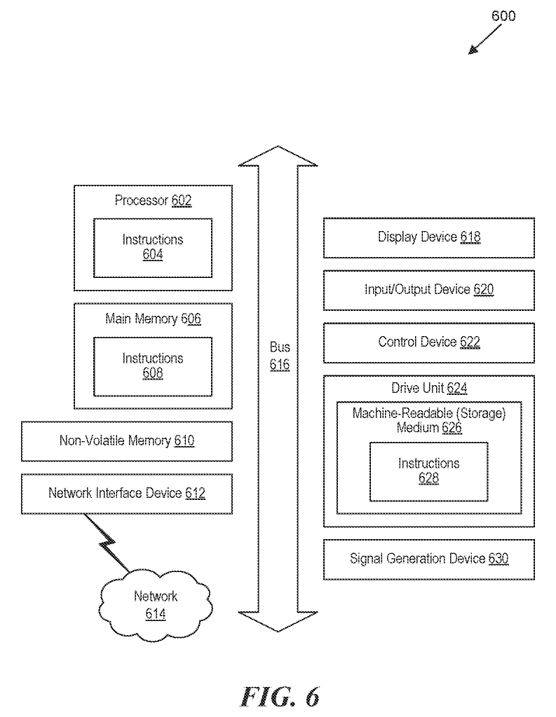

FIG. 4 is a flow chart that illustrates a process 400 for managing network performance using KPIs in accordance with some embodiments. The process can be performed by a system (e.g., the server system 302 in FIG. 3) associated with a telecommunications network service provider (e.g., a service provider of the network 100 in FIG. 1). The system is in communication with a wireless device (e.g., the wireless device 202 in FIG. 3) and one or more network monitoring elements (e.g., the network monitoring elements 312 in FIG. 3). The system can include at least one hardware processor and at least one non-transitory memory storing instructions (e.g., a computer system 600 described with respect to FIG. 6). When the instructions are executed by the at least one hardware processor, the system performs the process 400.

The process 400 is directed to managing network performance using KPIs. Specifically, in order to provide accurate and timely surge slice networking services, the process provides for real-time monitoring of network performance KPIs from both network infrastructure and user devices. The described technology enables simultaneous collection and merging of KPI sets from these sources. By analyzing the merged KPIs, the system can detect discrepancies between the network’s and the user device’s experienced performance. These discrepancies are used for determining whether a user device currently needs an upgrade of its network service and/or predicting whether the user device would need an upgrade in the near future. The process can therefore proactively provide upgraded network services, such as a surge network slice, to the user device.

At 402, the system receives a first set of key performance indicator (KPI) values from a base station of the telecommunications network. For example, the server system 302 receives a set of KPIs from the network monitoring elements 312 in FIG. 3. The network monitoring elements 312 include a base station, such as one of the base stations 102 in FIG. 1. The first set of KPI values indicate performance of a network slice of the telecommunications network during a time period as experienced by the base station. The base station can, for example, collect and report KPI values periodically to the system. In some implementations, real-time KPI values can be reported ranging from every 1-5 seconds to every 5-15 minutes. In some implementations, the KPI values include one or more of: signal strength, signal quality, latency, throughput, packet loss, jitter, connection drop rate, handover success rate, call setup success rate, data session setup success rate, battery consumption, or network availability. In some embodiments, other network monitoring elements can collect and transmit real-time KPI values to the system, as described with respect to the network monitoring elements 312 in FIG. 3.

At 404, the system receives a second set of KPI values from an electronic device in communication with the base station via the network slice. The second set of KPI values describe the performance of the network slice as experienced by the electronic device during the time period. For example, both the first and second sets of KPI values are collected at the same time period (e.g., the past 1-5 seconds or the past 5-15 minutes). The KPI values and/or the first and second sets of KPI values can be time-stamped to indicate the time associated with each of the KPI values of the KPI value set.

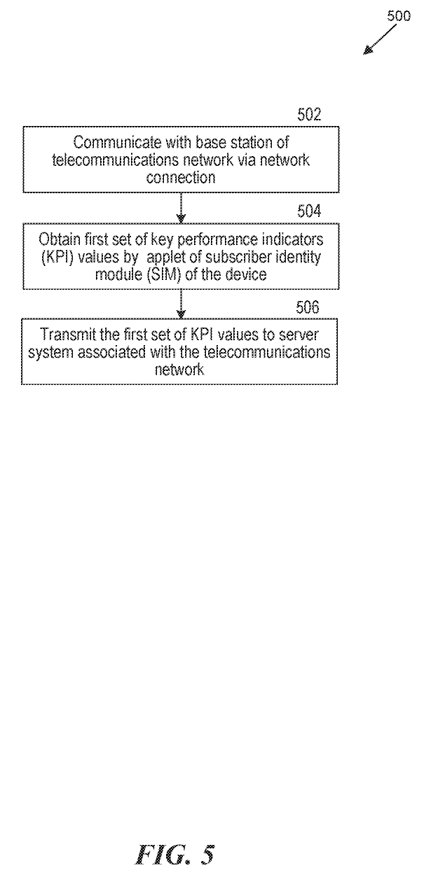

In some implementations, the electronic device is configured to obtain KPI values on a hardware layer of the electronic device or an operating system associated with a software layer of the electronic device. The electronic device can be configured to periodically transmit the obtained KPI values to the system. The obtained KPI values can include the second set of KPI values. In some implementations, the electronic device monitors the network performance by collecting KPI values via one or more SIM applets on the electronic device, as described with respect to the process illustrated in FIG. 5.

In some implementations, the electronic device includes a network monitoring application (e.g., the application 314 in FIG. 3) configured to obtain KPI values on the electronic device. The network monitoring application can be configured to periodically transmit the obtained KPI values to the system. The obtained KPI values can include the second set of KPI values. The network monitoring application can be associated with the server system 302 associated with the network service provider, as described with respect to FIG. 1. Alternatively, the network monitoring application can be associated with the application server 310, which can be a third-party application server in communication with the wireless device 202.

In some implementations, the electronic device includes a software application (e.g., the application 314 in FIG. 3) associated with an additional server system (e.g., the application server 310) and configured to provide a wireless service on the electronic device. The software application can be configured to obtain KPI values on the electronic device and transmit the obtained KPI values to the additional server system. The additional server system can be configured to transmit the obtained KPI values to the system. The obtained KPI values can include the second set of KPI values.

At 406, the system merges the first set of KPI values and the second set of KPI values to generate a merged set of KPI values indicative of the performance of a network slice of the telecommunications network during the time period as experienced by the base station and the performance of the network slice as experienced by the electronic device during the time period. In some implementations, the merging is done by the surge slice engine 308 of the server system 302 in FIG. 3. Generating the merged set of KPIs can include combining the first set of KPI values and the second set of KPI values and storing them in the database 306.

At 408, the system identifies using the merged set of KPI values one or more discrepancies between the first set of KPI values and the second set of KPI values. As explained above, the network performance experienced by the user devices can be different from the network performance experienced by the network infrastructure, for example, because several extrinsic factors can influence the network performance. As an example, extrinsic factors such as user device density, geographical terrain, user device mobility, physical obstructions, radio interference, or weather can reduce the quality of network performance experienced by wireless devices. By processing the merged set of KPIs to identify the discrepancies, the system can receive a more accurate understanding of the real-time network performance.

Using the identified one or more discrepancies, at 410 the system identifies whether the electronic device requires (or benefits from) an upgrade of the network slice. Identifying whether the electronic device requires an upgrade can be associated with one or more of the KPI values. In some implementations, the system determines whether the one or more discrepancies are outside (e.g., below or above) a predetermined threshold range for the one or more KPI values. Further, the system can consider additional factors such as current or predicted load of the network and/or current or predicted demand experienced by the network in identifying whether the electronic device requires the upgrade of the network slice. The determination can include processing historical usage patterns for the geographical area and/or specific applications in identifying whether the electronic device requires an upgrade.

In response to an identification that the electronic device requires an update to the first network slice, at 412 the system initiates establishing the upgrade of the network slice. The server system can facilitate the establishment of the upgrade of the network slice by, for example, transmitting a request for an upgraded network slice to the DN 220 in FIG. 8. In some implementations, the network slice that the electronic device is currently connected to is defined by a first set of parameters. Establishing the upgrade of the network slice can include establishing an additional network slice that is defined by a second set of parameters different from the first set of parameters between the electronic device and the base station. The set of parameters can define network slice properties, such as bandwidth, jitter, latency, reliability, or geographical scope.

In some implementations, the electronic device is in communication with the network via a regular network connection (i.e., not a slice connection such as a shared network connection). In such implementations, the system can determine whether the electronic device would require, or benefit from, an establishment of a network slice and establish such a network slice connection accordingly. In some implementations, the system forgoes initiating the establishment of the upgrade of the network slice in response to a determination that the electronic device does not require the upgrade of the first network slice. For example, the discrepancies identified in the merged set of KPIs are within a pre-determined threshold range that is considered to provide sufficiently good network performance, and no upgrade is needed.

In some implementations, the system can identify, using the second set of KPI values, that the electronic device is operating a software application of a particular type that facilitates communication with the network slice. For example, when the electronic device is using a particular type of application (e.g., an application for video conferencing, video streaming, cloud gaming, etc.), the KPIs can create a pattern (e.g., a profile) that is characteristic of that application. Determining whether the electronic device requires the upgrade of the network slice can be performed using the particular type of the software application. For example, the system can associate certain network slice properties with the particular type of application based on the characteristic pattern of KPI values.

In some implementations, the particular software application (e.g., the application 314 in FIG. 3) is associated with a particular server system (e.g., the application server 310 in FIG. 3) different from the system. Responsive to the determination that the electronic device is operating the particular software application and prior to initiating the establishment of the upgrade of the network slice, the system can transmit a request to the particular server system to approve the upgrade of the network slice. In some embodiments, the upgrade can be associated with additional cost to the application server and/or to the user of the electronic device. For example, the particular software application can be a video conferencing application. The system can transmit a request to the application server 310 to approve the upgrade of the network slice with a particular cost. The application server 310 can approve the upgrade and the particular cost. In some implementations, the system transmits to the electronic device, prior to initiating the establishment of the upgrade of the network slice, a request to approve the upgrade of the network slice. For example, the request is sent to the wireless device 202 so that the user of the wireless device approves the upgrade of the network slice and the particular cost.

In some implementations, the particular software application is operated using a required set of connectivity parameters. The system can transmit a request to the particular server system to modify one or more parameters of the set of connectivity parameters. For example, if the system detects that the network slice connection will likely cause performance issues for using the particular software application, the system can provide an indication of the performance issue to the particular server system so that the particular server system can lower the requirements for the connectivity. This can include, for example, reducing the video quality or audio quality of a streaming application.

In some implementations, the system receives customer profile information associated with a user of the electronic device. The customer profile information can include information associated with the historical behavior of the user and historical data usage by the electronic device. As an example, the user’s historical behavior can include using video conferencing applications during working hours, using web-based map services during morning and evening commutes, and using video streaming or music streaming during evenings. Determining whether the electronic device requires the upgrade of the network slice is further performed using the customer profile information.

In some implementations, the system receives a geographic location of the electronic device and stores the geographic location of the electronic device to the merged set of KPI values. The geographic location can be obtained by one or more location or movement sensors of the electronic device (e.g., GPS or inertial sensors such as accelerometer, gyroscope, or magnetometer). In some embodiments, geographic location is obtained by cellular network positioning. Determining whether the electronic device requires the upgrade of the network slice can be further performed using the geographic location of the electronic device. In some implementations, the system can also receive information regarding the movement of the electronic device (e.g., based on the location sensors). The movement can include, for example, speed and the direction of a user driving a vehicle while using a web-based mapping application.

As an example, the system can determine, using the geographic location and movement of the electronic device, that the user is driving on a highway. The system can further determine that the electronic device is experiencing poor network performance. However, the system can determine, using the location and movement information, that the user is heading to a coverage area of a different base station and soon will be likely to experience better network quality. In such an instance, the system can determine that no action is required. In another example, the system can determine that the user is heading toward a geographical region that is generally experiencing poor network performance. The region can have, for example, terrestrial obstacles, such as a dense forest or a mountain. In such instances, the system can determine that the electronic device should be upgraded to a different network slice.

In some implementations, the system predicts, using the identified one or more discrepancies, a trend (e.g., a future trend) for the performance of the network slice as experienced by the electronic device. Determining whether the electronic device requires an upgrade of the network slice can be performed using the trend. In some implementations, determining whether the electronic device requires the upgrade of the network slice can include inputting to an artificial intelligence (AI) model the identified one or more discrepancies. The AI model can be operated on an AI system such as the AI system 700 described with respect to FIG. 7. The AI system can be in communication with the system (e.g., the surge slice engine 308 in FIG. 3). In some implementations, the AI system can operate as part of the system. The AI model can be configured to predict, using the identified one or more discrepancies, whether the electronic device is likely to experience a partial or full disruption in communication with the slice network. For example, disruption can be defined as a set of one or more KPI values that are outside a predetermined threshold range of KPI values. Determining whether the electronic device requires the upgrade of the network slice can also include predicting, by the AI model, whether the electronic device has a disruption likelihood above a threshold disruption likelihood. For example, the AI model can identify, using the one or more discrepancies, that the network performance experienced by the electronic device is currently within the threshold range but can predict that the network performance is likely to be disrupted in the near future. Based on the prediction, the system can proactively initiate establishing an update for the network slice to mitigate the disruption.

In some implementations, the AI model can be trained using a training data set including training data comprising historical one or more discrepancies between KPI values received from one or more base stations of the telecommunications network and KPI values received from multiple wireless devices in communication with the one or more base stations via network slices. For example, the training data set can further include datapoints on whether the electronic devices experienced disruptions of network performance during the time periods that are associated with the historical one or more discrepancies. The training data set can, additionally or alternatively, include one or more discrepancies between KPI values of a network generated under simulated test conditions and KPI values received from one or more test wireless devices while in communication with the generated network under the simulated test conditions. The simulation can be performed, e.g., by positioning the one or more test wireless devices in a test chamber configured to simulate network signals and extrinsic factors affecting such signals.

FIG. 5 is a flow chart that illustrates a process 500 for monitoring KPI values for management of network performance of a telecommunications network in accordance with some embodiments. The process can be performed by an electronic device (e.g., the wireless device 202 in FIG. 3) in communication with a server system (e.g., the server system 302 in FIG. 3) and a base station (e.g., the base stations 102 in FIG. 1). The server system is associated with a telecommunications network service provider (e.g., a service provider of the network 100 in FIG. 1). The electronic device can include at least one hardware processor and at least one non-transitory memory storing instructions (e.g., the computer system 600 described with respect to FIG. 6). When the instructions are executed by the at least one hardware processor, the system performs the process 500.

Specifically, the process 500 is directed to monitoring KPI values for management of network performance where the KPI values are associated with the performance of the network as experienced by the electronic device. The KPI values can be obtained via one or more applets on a SIM on the electronic device. An applet can include a small-sized, specialized software program (e.g., applets) embedded within the SIM. The one or more applets can be programmed to access and collect a variety of KPI values that provide information about the network performance experienced by the user device. For example, the KPI values can include one or more of signal strength, signal quality, latency, throughput, packet loss, jitter, connection drop rate, handover success rate, call setup success rate, data session setup success rate, battery consumption, or network availability.

At 502, the electronic device communicates with the base station of the telecommunications network via a network connection between the electronic device and the telecommunications network. The network connection can be a slice network connection or a regular (e.g., shared or best-effort) network connection. The electronic device can include a subscriber identity module (SIM) associated with a service provider of the telecommunications network. The SIM can include an applet (e.g., the SIM applet 316 in FIG. 3) configured to monitor key performance indicator (KPI) values indicating the telecommunications network’s performance experienced by the electronic device.

In some implementations, the applet is pre-installed on the SIM prior to associating the SIM with the electronic device. For example, the SIM is a physical SIM card that is inserted into the electronic device and the SIM card includes the applet as part of the SIM chip.

In some implementations, the SIM is an embedded SIM (eSIM) embedded within the hardware of the electronic device. The applet can be installed and/or updated on the SIM by an over-the-air technology.

While communicating with the base station, at 504 the electronic device can obtain a first set of KPI values by the applet of the SIM. The first set of KPI values can be obtained by the electronic device while monitoring the values of KPIs during a time period. The first set of KPI values are associated with the network performance as experienced by the electronic device.

At 506, the electronic device transmits the first set of KPI values to a server system (e.g., the server system 302 in FIG. 3) associated with the telecommunications network. The server system can be configured to merge the first set of KPI values with a second set of KPI values received from the base station (e.g., the network monitoring elements 312 in FIG. 3) to generate a merged set of KPI values. The second set of KPI values indicate the performance of the network connection as experienced by the base station during the time period.

The server system can be configured to identify, using the merged set of KPI values, one or more discrepancies between the first set of KPI values and the second set of KPI values. The system is configured to identify, using the identified one or more discrepancies, whether the electronic device has a probability of experiencing an interruption in the network connection that fails to satisfy a threshold probability value or a threshold probability range. For example, the probability of experiencing an interruption in the network connection determined by the system can be above the threshold probability value or range. The probability can be defined using one or more of the KPI values in the first and second sets of KPI values. In response to identifying that the electronic device has the probability of experiencing an interruption in the network connection that fails to satisfy the threshold probability value, the system is configured to perform an action to mitigate the probability of experiencing the interruption.

In some implementations, the action to mitigate the probability of experiencing the interruption includes initiating, at the server system, the establishment of an upgraded network slice connection between the electronic device and the base station, as described with respect to the process 400 in FIG. 4.

In some implementations, the electronic device is running a particular software application (e.g., the application 314 in FIG. 3) communicating with a particular server system (e.g., the application server 310) via the network connection. The action to mitigate the probability of experiencing the interruption can include transmitting, from the server system to the particular server system, a request to approve an upgrade of the network connection.

In some implementations, the particular software application can be operated using a required set of connectivity parameters. The action to mitigate the probability of experiencing the interruption can include transmitting, from the server system to the particular server system, a request to modify one or more parameters of the set of connectivity parameters. The request can include, for example, a request to reduce video quality or audio quality.

In some implementations, the SIM includes an additional applet configured to lock and unlock network connectivity features based on instructions received from the server system. The action to mitigate the probability of experiencing the interruption can include receiving, at the electronic device from the server system, an indication to unlock a connectivity feature that enables the electronic device to establish an upgrade of the network connection. For example, locking network connectivity features can include restricting a device’s ability to access certain networks or services—such as limiting it to a specific frequency band, or network type (e.g., 4G only). Unlocking these features removes such restrictions, allowing the device to connect freely to any compatible network or service as permitted by its hardware and software capabilities.

### Computer System

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a video display device 618, an input/output device 620, a control device 622 (e.g., keyboard and pointing device), a drive unit 624 that includes a machine-readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementations, the computer system 600 can be an embedded computer system, a system-on-chip (SOC), a single-board computer system (SBC), or a distributed system such as a mesh of computer systems, or it can include one or more cloud components in one or more networks. Where appropriate, one or more computer systems 600 can perform operations in real-time, in near real-time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### AI System

FIG. 7 is a block diagram that illustrates an example of an AI system 700 in which at least some operations described herein can be implemented. As shown, the AI system 700 can include a set of layers, which conceptually organize elements within an example network topology for the AI system’s architecture to implement a particular AI model 730. Generally, an AI model 730 is a computer-executable program implemented by the AI system 700 that analyzes data to make predictions. Information can pass through each layer of the AI system 700 to generate outputs for the AI model 730. The layers can include a data layer 702, a structure layer 704, a model layer 706, and an application layer 708. The algorithm 716 of the structure layer 704 and the model structure 720 and model parameters 722 of the model layer 706 together form the example AI model 730. The optimizer 726, loss function engine 724, and regularization engine 728 work to refine and optimize the AI model 730, and the data layer 702 provides resources and support for the application of the AI model 730 by the application layer 708.

The data layer 702 acts as the foundation of the AI system 700 by preparing data for the AI model 730. As shown, the data layer 702 can include two sub-layers: a hardware platform 710 and one or more software libraries 712. The hardware platform 710 can be designed to perform operations for the AI model 730 and include computing resources for storage, memory, logic, and networking, such as the resources described in relation to FIG. 5. The hardware platform 710 can process amounts of data using one or more servers. The servers can perform backend operations such as matrix calculations, parallel calculations, machine learning (ML) training, and the like. Examples of servers used by the hardware platform 710 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 710 can include Infrastructure as a Service (IaaS) resources, which are computing resources (e.g., servers, memory, etc.) offered by a cloud services provider. The hardware platform 710 can also include computer memory for storing data about the AI model 730, application of the AI model 730, and training data for the AI model 730. The computer memory can be a form of random-access memory (RAM), such as dynamic RAM, static RAM, and non-volatile RAM.

The software libraries 712 can be thought of as suites of data and programming code, including executables, used to control the computing resources of the hardware platform 710. The programming code can include low-level primitives (e.g., fundamental language elements) that form the foundation of one or more low-level programming languages, such that servers of the hardware platform 710 can use the low-level primitives to carry out specific operations. The low-level programming languages do not require much, if any, abstraction from a computing resource’s instruction set architecture, allowing them to run quickly with a small memory footprint.

The structure layer 704 can include an ML framework 714 and an algorithm 716. The ML framework 714 can be thought of as an interface, library, or tool that allows users to build and deploy the AI model 730. The ML framework 714 can include an open-source library, an application programming interface (API), a gradient-boosting library, an ensemble method, and/or a deep learning toolkit that work with the layers of the AI system to facilitate the development of the AI model 730. For example, the ML framework 714 can distribute processes for the application or training of the AI model 730 across multiple resources in the hardware platform 710. The ML framework 714 can also include a set of pre-built components that have the functionality to implement and train the AI model 730 and allow users to use pre-built functions and classes to construct and train the AI model 730. Thus, the ML framework 714 can be used to facilitate data engineering, development, hyperparameter tuning, testing, and training for the AI model 730.

The algorithm 716 can be an organized set of computer-executable operations used to generate output data from a set of input data and can be described using pseudocode. The algorithm 716 can include complex code that allows the computing resources to learn from new input data and create new/modified outputs based on what was learned. In some implementations, the algorithm 716 can build the AI model 730 through being trained while running computing resources of the hardware platform 710. This training allows the algorithm 716 to make predictions or decisions without being explicitly programmed to do so. Once trained, the algorithm 716 can run at the computing resources as part of the AI model 730 to make predictions or decisions, improve computing resource performance, or perform tasks. The algorithm 716 can be trained using supervised learning, unsupervised learning, semi-supervised learning, and/or reinforcement learning.

### Network Slicing

FIG. 8 is a block diagram that illustrates an example network slicing environment 800 in which at least some operations described herein can be implemented. The network slicing environment 800 can be operated in a 5G network. The network slicing environment 800 enables multiplexing of virtualized and independent logical networks (i.e., network slices NS1 through NS4) on the same physical network infrastructure. In 5G wireless networks, network slicing assumes a central role designed to efficiently embrace multiple services with very different service-level requirements (e.g., data transfer speed, reliability, bandwidth). The end-to-end network slices can be defined between wireless devices (e.g., wireless devices 802, 804, and 806) and DN 220. For example, each network slice is an isolated end-to-end network tailored to fulfill diverse requirements requested by a particular application (e.g., wireless applications 1 through 4 associated with the wireless devices 802, 804, and 806). The network slicing environment 800 can be in communication with public and private clouds 808. For example, the clouds 808 can include cloud servers associated with the different wireless applications 1 through 4. While FIG. 8 demonstrates a network slicing environment in a 5G network, one of skill in the art would understand that the features disclosed herein would apply to other network topologies as well (e.g., 3G, 4G, 6G, and LTE).

An infrastructure associated with the network slicing system includes hardware and software resources, such as user equipment and/or compute-, storage-, and networking-hardware equipment, as well as the services and software programs stored therein. The infrastructure can be used to implement physical network nodes and/or to define a distributed cloud environment, such as Physical Network Functions (PNFs) and/or the Network Functions Virtualization Infrastructure (NFVI). The infrastructure provides the support and management functionality that allows for the deployment and operation of individual network slices. The infrastructure can include a collection of PNFs. For example, it provides the user control and application plane functionality across the different network segments, including the RAN slices (e.g., via the RAN 204) between wireless devices (e.g., wireless devices 802, 804, and 806) and the UPF 216 and transport slices between the UPF 216 and DN 220.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A server system for managing surge network slicing in a telecommunications network, the server system comprising:
at least one hardware processor; and
at least one non-transitory memory storing instructions, which, when executed by the at least one hardware processor, cause the system to:
receive a first set of key performance indicator (KPI) values from a base station of the telecommunications network,
wherein the first set of KPI values indicate performance of a network slice of the telecommunications network during a first time period as experienced by the base station;
receive a second set of KPI values from an electronic device in communication with the base station via the network slice,
wherein the second set of KPI values indicate performance of the network slice as experienced by the electronic device during the first time period;
merge the first set of KPI values and the second set of KPI values to generate a merged set of KPI values indicative of the performance of a network slice of the telecommunications network during the first time period as experienced by the base station and the performance of the network slice as experienced by the electronic device during the first time period;
identify, using the merged set of KPI values, one or more discrepancies between the first set of KPI values and the second set of KPI values;
using the identified one or more discrepancies, identify whether the electronic device requires an upgrade of the network slice; and
in response to an identification that the electronic device requires the upgrade of the first network slice, initiate establishment of the upgrade of the network slice.

2. The server system of claim 1,
wherein the electronic device is configured to obtain KPI values on a hardware layer of the electronic device or an operating system associated with a software layer of the electronic device, and
wherein the electronic device is configured to periodically transmit the obtained KPI values to the system, the obtained KPI values comprising the second set of KPI values.

3. The server system of claim 1,
wherein the electronic device comprises a network monitoring application configured to obtain KPI values on the electronic device, and
wherein the network monitoring application is configured to periodically transmit the obtained KPI values to the server system, the obtained KPI values comprising the second set of KPI values.

4. The server system of claim 1,
wherein the electronic device comprises a software application associated with an additional server system and configured to provide a wireless service on the electronic device,
wherein the software application is configured to obtain KPI values on the electronic device,
wherein the software application is configured to transmit the obtained KPI values to the additional server system, and
wherein the additional server system is configured to transmit the obtained KPI values to the server system, the obtained KPI values comprising the second set of KPI values.

5. The server system of claim 1, further caused to:
identify, using the second set of KPI values, that the electronic device is operating a software application of a particular type that facilitates the communication with the network slice,
wherein whether the electronic device requires the upgrade of the network slice is further determined using the particular type of the software application.

6. The server system of claim 1, further caused to:
determine, using the second set of KPI values, that the electronic device is operating a particular software application that facilitates the communication with the network slice,
wherein the particular software application is associated with a particular server system different from the server system; and
responsive to the determination that the electronic device is operating the particular software application and prior to initiating the establishment of the upgrade of the network slice, transmit a request to the particular server system to approve the upgrade of the network slice.

7. The server system of claim 1, further caused to:
determine that the electronic device is operating a particular software application that facilitates the communication with the network slice,
wherein the particular software application is associated with a particular server system different from the server system, and
wherein the particular software application is operated using a required set of connectivity parameters; and
transmit a request to the particular server system to modify one or more parameters of the set of connectivity parameters.

8. The server system of claim 1, further caused to:
prior to initiating the establishment of the upgrade of the network slice, transmit, to the electronic device, a request to approve the upgrade of the network slice.

9. The server system of claim 1, further caused to:
receive customer profile information associated with a user of the electronic device,
wherein the customer profile information comprises information associated with historical behavior of the user and historical data usage by the electronic device; and
wherein whether the electronic device requires the upgrade of the network slice is further determined using the customer profile information.

10. The server system of claim 1, further caused to:
receive a geographic location of the electronic device; and
store the geographic location of the electronic device to the merged set of KPI values,
wherein whether the electronic device requires the upgrade of the network slice is further determined using the geographic location of the electronic device.

11. The server system of claim 1,
wherein the network slice is defined by a first set of parameters, and
wherein the establishment of the upgrade of the network slice comprises establishing an additional network slice that is defined by a second set of parameters different from the first set of parameters.

12. The server system of claim 1, further caused to:
in response to a determination that the electronic device does not require the upgrade of the first network slice, forgo initiating the establishment of the upgrade of the network slice.

13. The server system of claim 1, further caused to:
predict, using the identified one or more discrepancies, a future trend for the performance of the network slice as experienced by the electronic device,
wherein whether the electronic device requires the upgrade of the network slice is further determined using the future trend.

14. The server system of claim 1,
wherein determining whether the electronic device requires the upgrade of the network slice comprises:
inputting, to an artificial intelligence (AI) model, the identified one or more discrepancies,
wherein the AI model is configured to predict, using the identified one or more discrepancies, whether the electronic device is likely to experience a partial or full disruption in communication with the slice network; and
predicting, by the AI model, whether the electronic device has a disruption likelihood above a threshold disruption likelihood.

15. The server system of claim 14,
wherein the AI model is trained using a training data set comprising:
training data comprising historical one or more discrepancies between KPI values received from one or more base stations of the telecommunications network and KPI values received from multiple wireless devices in communication with the one or more base stations via network slices, and/or
training data comprising one or more discrepancies between KPI values of a network generated under simulated test conditions and KPI values received from one or more test wireless devices while in communication with the generated network under the simulated test conditions.

16. A method, performed by a server system, for managing surge network slicing in a telecommunications network, the method comprising:
receiving a first set of key performance indicator (KPI) values from a base station of the telecommunications network,
wherein the first set of KPI values indicate performance of a network connection of the telecommunications network during a first time period as experienced by the base station;
receiving a second set of KPI values from an electronic device in communication with the base station via the network connection,
wherein the second set of KPI values indicates performance of the network connection as experienced by the electronic device during the first time period;
merging the first set of KPI values and the second set of KPI values to generate a merged set of KPI values indicative of the performance of a network slice of the telecommunications network during the first time period as experienced by the base station and the performance of the network slice as experienced by the electronic device during the first time period;
identifying, using the merged set of KPI values, one or more discrepancies between the first set of KPI values and the second set of KPI values;
using the identified one or more discrepancies, identifying whether the electronic device has a probability of experiencing an interruption in the network connection that fails to satisfy a threshold probability value; and
in response to identifying that the electronic device has the probability of experiencing the interruption in the network connection that fails to satisfy the threshold probability value, performing an action to mitigate the probability of experiencing the interruption.

17. The method of claim 16,
wherein the action to mitigate the probability of experiencing the interruption comprises initiating, by the server system, establishment of an upgraded network connection between the electronic device and the base station.

18. The method of claim 16,
wherein the electronic device is operating a particular software application communicating with a particular server system via the network connection, and
wherein the action to mitigate the probability of experiencing the interruption comprises transmitting, by the server system to the particular server system, a request to approve an upgrade of the network connection.

19. At least one non-transitory, computer-readable storage medium comprising instructions recorded thereon, wherein the instructions, when executed by at least one data processor of a server system of a telecommunications network, cause the system to:
receive a first set of key performance indicator (KPI) values from a base station of the telecommunications network,
wherein the first set of KPI values indicate performance of a network connection of the telecommunications network during a time period as experienced by the base station;
receive a second set of KPI values from an electronic device in communication with the base station via the network connection,
wherein the second set of KPI values indicates performance of the network connection as experienced by the electronic device during the first time period;
merge the first set of KPI values and the second set of KPI values to generate a merged set of KPI values indicative of the performance of a network slice of the telecommunications network during the first time period as experienced by the base station and the performance of the network slice as experienced by the electronic device during the first time period;
identify, using the merged set of KPI values, one or more discrepancies between the first set of KPI values and the second set of KPI values;
using the identified one or more discrepancies, identify whether the electronic device has a probability of experiencing an interruption in the network connection that fails to satisfy a threshold probability value; and
in response to identifying that the electronic device has the probability of experiencing the interruption in the network connection that fails to satisfy the threshold probability value, performing an action to mitigate the probability of experiencing the interruption.

20. The at least one non-transitory, computer-readable storage medium of claim 19,
wherein the action to mitigate the probability of experiencing the interruption comprises initiating, by the server system, establishment of an upgraded network connection between the electronic device and the base station.
